(19) United States
(12) Patent Application Publication
(10) Pub. No.: US 2017/0087510 A1
(43) Pub. Date: Mar. 30, 2017

(54) Aqua-Catalysed Chalked Lime Scrubbing Processes and Systems

(71) Applicant: RIO TINTO ALCAN INTERNATIONAL LIMITED, Montréal (CA)

(72) Inventors: Jean-Nicolas MALTAIS, Chicoutimi (CA); Simon LECLERC, Jonquière (CA); Cyril GAUDREAULT, Jonquière (CA)

(73) Assignee: RIO TINTO ALCAN INTERNATIONAL LIMITED, Montreal (CA)

(21) Appl. No.: 15/315,505

(22) PCT Filed: Jun. 2, 2015
(86) PCT No.: PCT/CA2015/050508

§ 371 Date: Dec. 1, 2016

Related U.S. Application Data
(60) Provisional application No. 62/006,387, filed on Jun. 2, 2014.

(51) Int. Cl. B01D 53/40; B01D 53/02; B01D 53/81

(52) U.S. Cl. CPC B01D 53/40; B01D 53/81; B01D 53/02; B01D 2258/0283; B01D 2251/404; B01D 2257/302

(57) ABSTRACT

A dry scrubbing system and process wherein an acid gas comprising at least one pollutant is modified in a humid zone of a duct such that a relative humidity of between 2% and 90% is achieved. The humidified gas is then contacted with chalked lime in a reaction zone. The reaction zone components are subsequently filtered in a filtering zone to provide a filtered gas having reduced concentration of the at least one pollutant when compared to the initial acid gas.

### CROSS-REFERENCE TO RELATED APPLICATION(S)

This application claims priority from U.S. provisional patent application Ser. No. 62/006,387 filed on Jun. 2, 2014 and herewith incorporated in its entirety.

### TECHNOLOGICAL FIELD

The present disclosure relates to dry scrubbing processes and systems associated thereto for removing pollutants from acid gases. The dry scrubbing system described herein uses, as a pollutant sorbent, chalked lime to remove impurities from an acid gas having an initial temperature of at least 20° Celsius and having been treated to have a relative humidity between 2% and 90%.

### BACKGROUND

Operations such as coke production and alumina electrolysis, which are common in the aluminum industry, generate acid gases (also referred to as flue gases) containing various pollutants. Facilities for coke or aluminum production usually operate with emission limits set by competent authorities. In order to reduce such emissions, it is possible to implement “end-of-pipe” scrubbing processes to remove or capture pollutants from fumes.

Existing end-of-pipe scrubbing processes include dry scrubbing processes (in which a dry or semi-dry sorbent is injected in a pollutant-laden gas) and wet scrubbing processes (in which a pollutant-laden gas is sprayed with a solution comprising a dissolved sorbent). Existing dry scrubbing systems usually require the use of large infrastructure like a reactor to enhance the reaction between the sorbent with the pollutants and/or a recirculating system to send back the unused/unreacted sorbent/by-products with the acid gases to maximize the consumption of sorbent. Disadvantages of existing wet scrubbing processes include complex processing controls, the use of large infrastructures (e.g., spray towers, sorbent regenerating plant for example) as well as the generation of semi-liquid by-products that are difficult to manage.

It would be highly desirable to be provided with a scrubbing system for removing pollutants from acid gases which would further enhance the contact between the pollutants and the sorbent or maximize the sorbent and pollutant neutralization reaction to ultimately achieve higher pollutant removal efficiencies and/or limit the generation of unreacted sorbent when compared to conventional scrubbing systems. Preferably such system would not include a recirculating component for recycling unreacted sorbent or by-products of the reaction.

### BRIEF SUMMARY

The present disclosure provides a dry scrubbing process as well as related system for reducing the concentration of a pollutant from an acid gas. In the dry scrubbing processes and systems described herewith, the relative humidity of the gas to be treated is adjusted prior to the contact with the sorbent to enhance the scrubbing efficiency.

According to a first aspect, the present disclosure provides a dry scrubbing system for reducing the concentration of a pollutant from an acid gas. The dry scrubbing system comprises a first duct (for carrying the acid gas, wherein the first duct defines a first opening allowing entry of the acid gas in the dry scrubbing system and a second opening for carrying a treated gas), at least one sorbent injector (operatively connected to the first duct at a first location to add chalked lime inside the first duct), means for adjusting the relative humidity of the acid gas (operatively connected to first duct at a second location, wherein the means for adjusting the relative humidity of the acid gas is at a location between the first opening and the at least one sorbent injector) and at least one filter (for separating solid particles from the treated gas, wherein the filter is connected to the second opening of the first duct and wherein the filter is connected to a third opening of a third duct allowing exit of the treated gas from the dry scrubbing system). In an embodiment, the means for adjusting the relative humidity of the acid gas is at least one water injector for adding water inside the first duct. In such embodiment, the location of the at least one water injector (second location) with respect to the location of the sorbent injector (first location) allows the vaporization of the water of the acid gas prior to contacting the chalked lime. In another embodiment, the at least one water injector for injecting liquid water (such as, for example, liquid water droplets). In another embodiment, the dry scrubbing system further comprises at least one probe for determining the temperature and/or the relative humidity of the acid gas and/or the treated gas. The probe can be, for example, proximal to the third opening and/or the means for adjusting the relative humidity of the acid gas.

According to a second aspect, the present disclosure provides a process for reducing the concentration of at least one pollutant from an acid gas. Broadly, the process comprises (a) providing an initial acid gas comprising the pollutant; (b) modifying the initial acid gas to obtain a humid gas having a relative humidity between about 2% to 90%; (c) adding chalked lime to the humid gas to obtain a reaction mixture; and (d) filtering the reaction mixture to separate solid particles and obtain a filtered gas having a reduced concentration of the at least one pollutant when compared to the initial acid gas. In an embodiment, step (b) further comprises adding water to the initial gas and/or reducing the temperature of the initial gas to obtain the humid gas. In another embodiment, the pollutant is at least one of SO₂, SO₃, CO₂, HF, NOₓ and combinations thereof. In still another embodiment, the acid gas is an emission from a calcined coke production facility or an alumina electrolysis facility. In a further embodiment, the relative humidity of the humid gas is about 60%. In yet another embodiment, the particles of the chalked lime have a relative size of less 0.045 mm for at least 10% of the particles and less than 0.6 mm for 100% of the particles. In another embodiment, the process further comprises (e) determining the relative humidity of the filtered gas; and (f) further modifying the initial gas at step (b) if the relative humidity of the filtered gas is less than about 2% or more than about 90%.

### BRIEF DESCRIPTION OF THE DRAWINGS

Having thus generally described the nature of the invention, reference will now be made to the accompanying drawings, showing by way of illustration, a preferred embodiment thereof, and in which:

FIG. 1 provides a diagram of one embodiment of the process described herein for reducing the concentration of at least one pollutant in an acid gas.

FIG. 2 illustrates an embodiment of the dry scrubbing system for reducing the concentration of at least one pollutant in an acid gas.

FIG. 3 illustrates that relative humidity of the gas, prior to the sorbent injection, modulates the scrubbing efficiency. Results are shown as scrubbing efficiency (provided in %) in function of the relative humidity of the gas (provided in %).

FIG. 4 illustrates the scrubbing efficiency (♦, provided in %) as a function of relative humidity (□, provided in %) and gas temperature (° C.).

### DETAILED DESCRIPTION

The systems and processes were designed to implement an improved dry-scrubbing of acid gases. In the systems and the processes described herein, the relative humidity of the acid gas is adjusted prior to contacting a dry pollutant sorbent (e.g., chalked lime). In order to do so, water can be added to the acid gas and/or temperature of the acid gas can be adjusted to increase the overall relative humidity of the acid gas, to allow the vaporization of water present in the gas so as to provide a humid gas to be contacted with the dry pollutant sorbent. The system described herein provides means for adjusting the relative humidity which are located upstream (in relationship of the flow of the acid gas) of the means for providing the pollutant sorbent. The system also defines a zone for allowing the vaporization of the water present in the gas prior to contacting the dry pollutant sorbent. The process described herein provides a step of adjusting the relative humidity of the acid gas so as to allow the vaporization of the water in the gas prior to contacting the dry pollutant sorbent. In some embodiments of the systems and the processes described herein, it is possible to conduct the scrubbing operations with no sorbent reactor. In other embodiments, the systems and processes described herein limit or avoid sorbent clogging, use less pollutant sorbent, limit or avoid recycling the pollutant sorbent and/or increase or maximize pollutant sorbent efficiency.

Throughout this application, various terms are used and some of them are more precisely defined herein.

Acid dew point temperature. In the context of the present disclosure, the “acid dew point temperature” refers to the temperature at which a gaseous acid at a given pressure transitions from the vapor state to the liquid state. For SO₂, SO₃, CO₂, HF and/or NOₓ-laden gases, the acid dew point temperature depends on the weight percentage of water in the gas mixture as well as the concentration of the gaseous pollutants. In some of the embodiments explained herein, the process temperature during the scrubbing operations can be maintained higher (e.g., at least 10° C. higher) than the acid dew point temperature of the untreated acid gas to avoid acidic condensation in the scrubbing system (and ultimately premature aging or corrosion of the system).

Acid gas. An “acid gas”, also referred to as a “flue gas”, is an emission comprising a gaseous acid pollutants, such as SO₂, SO₃, CO₂, HF and/or NOₓ-laden gases. Acid gases can be generated during many processes related to aluminum production (e.g., coke calcination, anode baking, reduction, etc.). The scrubbing systems and operations described herein apply to any acid gas, irrespective of pollutant composition or concentration, provided that the acid gas has an initial temperature (prior to humidification and scrubbing) of at least 20° C. For example, at the end of the coke production (but before the scrubbing operation), the acid gases can have a temperature of at least about 200° C. or even higher. In another example, acid gases generated during the electrolysis of alumina and can have a temperature between about 90 to 100° C. As such, the scrubbing systems and operations described herein can specifically apply to acid gases generated during coke production/utilization as well as those generated during alumina electrolysis. In some embodiments, the acid gas comprises oxygen (O₂).

Chalked lime. In the context of the present disclosure, chalked lime is a dry Ca(OH)₂ powder which is being used as a sorbent to scrub the pollutant(s) from the acid gas. The chalked lime is considered “dried” because no water has been added to dilute the chalked lime or make a lime solution prior to the scrubbing operation.

Dry scrubbing process. A dry scrubbing process or operation uses a sorbent in a dried form. In the context of the present disclosure, water (in any physico-chemical state such as solid, liquid or gaseous) and/or equipment to lower temperature of the acid gas can be used in the process to adjust the relative humidity and temperature of the acid gas to be treated (e.g., scrubbed), before the sorbent injection. However, in the dry scrubbing processes of the present disclosure, water is not used to dilute, suspend or form a solution with the sorbent itself. For example, a thin layer scrubbing operation in which the pollutant sorbent has been hydrated or otherwise contacted with water prior to contacting the untreated acid gas is not considered a dry scrubbing process. It is however contemplated that a thin layer scrubbing operation can be performed after the dry scrubbing process, for example when the hydrated lime forms a cake on the filter.

Humidity. Absolute humidity is the mass of water vapor per unit volume of total gas at a specific temperature and a specific pressure. Saturating humidity is the maximal mass of water vapor per unit volume of total gas that a gas can contain. Absolute and saturating humidity are usually provided as g/m³. Relative humidity is the ratio of the water vapor mass in a specific gas volume (e.g., absolute humidity) to the maximal water vapor mass (saturating humidity).

Pollutant. In the context of the present disclosure, a “pollutant” is a gaseous acid compound (SO₂, SO₃, CO₂, HF and/or NOₓ for example) present in a gaseous emission which may exhibit undesired effects.

The present disclosure provides dry scrubbing processes as well as associated dry scrubbing systems in which the acid gas, prior to being contacted with chalked lime, has a temperature of at least 20° C. and is contacted with water (in any state, solid, liquid or gaseous) to achieve a specific range of relative humidity in the humidified gas (e.g., between 2% to 90%). Without wishing to be bound to theory, it is believed that the pre-humidification of the acid prior to the addition of the dry sorbent enhances/catalyses the reaction of the acid gas pollutants and the sorbent. In some embodiments, the water addition to the acid gases provides a humidified gas having a temperature which is at least 10° C. higher than the acid dew point temperature of the initial untreated gas entering the system. As it is discussed herein, treating a gas which has been water-conditioned prior to dry sorbent injection increases scrubbing efficiency. In some embodiments, this water treatment allows for reducing the amount of chalked lime used, reducing the amount of unreacted chalked lime at the end of the scrubbing process, thus abrogating the need of recycling unreacted by-products obtained at the end of the scrubbing process. Further, in some embodiments, the scrubbing process described herein is not limited to hot gases and can be applied to any gas having a temperature of at least 20° C. or above, prior to the humidification step.

Without wishing to be bound to theory, it is believed that providing a humid gas enhances the chemical reaction between the gas pollutants and the chalked lime. It is postulated that the reduction of the temperature of the scrubbing process also increases the relative humidity of the gas, improves the association between chalked lime and water (by decreasing the water desorption rate and/or increasing the water adsorption rate on the chalked lime particles) and/or increases the reaction time between the pollutant and the sorbent. The presence of water on the surface of the chalked lime particles enhances their catalysis and therefore increases their reactivity towards the pollutants. It is believed that the association of water with the chalked lime particle surface creates a suitable situation to react with many different acid pollutant (SO₂, SO₃, HF, CO₂ and NOₓ) present in the gas, albeit with different efficiency rates. Some of the advantages of some of the embodiments of the processes described herein include, but are not limited to, less manipulation of the pollutant sorbent, a reduction in the agglomeration of pollutant sorbent, a reduction in clogging of the system as well as an overall simplicity (since no recirculation or reactor are required to achieve similar scrubbing efficiencies).

Dry Scrubbing Process

The present disclosure thus provides a process for reducing the concentration of at least one or a plurality of pollutants from an acid gas. In an embodiment, the process can be used to reduce the concentration of one pollutant from the acid gas, such as SO₂. In still another embodiment, the process can be used to advantageously produce a calcium sulfate by-product. As it will be shown herein, the pollutant scrubbing efficiency can depend on the level of relative humidity of the treated gas, the temperature of the treated gas and/or the quantity or type of sorbent injected during the process. This reduction in concentration can be, for example, a reduction in the concentration of the pollutant of at least 50%, 55%, 60%, 65%, 70%, 75%, 80%, 85%, 90%, 95%, 96%, 97%, 98% or 99% in the treated gas when compared to the initial untreated acid gas. In another embodiment, this process can be used to reduce the concentration of at least two, three or four pollutants from the acid gas. It is understood that, in such embodiment, not all pollutants will be reduced at the same level as some pollutants may be scrubbed more efficiently from the acid gas by the chalked lime than others. In an embodiment, the reduction in the concentration of each of the pollutant can independently be, for example, a reduction of at least 50%, 55%, 60%, 65%, 70%, 75%, 80%, 85%, 90%, 95%, 96%, 97%, 98% or 99% from the treated gas when compared to the initial untreated acid gas.

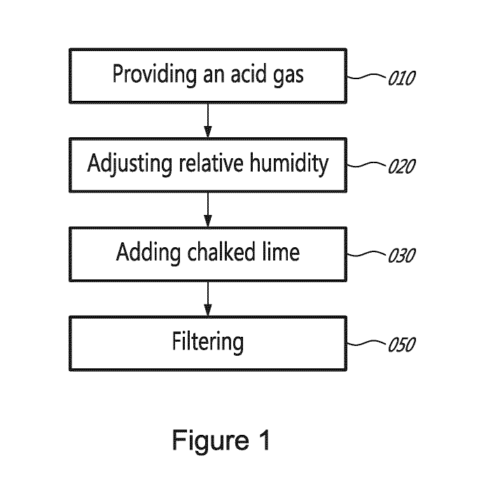

An exemplary process of the present disclosure is provided at FIG. 1. As a first step 010 of this dry scrubbing process, an acid gas to be scrubbed is provided. The process described herein can be applied to any acid gases, irrespective of its origin of emission. However, in an embodiment, the acid gas is an emission gas from a process related to aluminium production, such as, for example, from a coke production facility or an aluminum production facility. In such embodiment, the acid gas can be an emission gas from the calcination of coke (containing either a high or a low sulfur content). Step 010 can optionally comprise characterizing the acid gas to be treated prior to submitting it to the process. Such initial characterization can include determining the type and concentration of pollutants in the acid gas, the initial temperature of the acid gas, the acid dew point temperature of the acid gas, the flow of the acid gas, the temperature of the acid gas and/or the relative humidity of the acid gas. Such initial characterization can be used to determine (at least in part), the amount of water to be added at step 020, the temperature decrease required at step 020 and/or the amount and/or the amount/type of chalked lime to be added at step 030.

Once an acid gas has been provided at step 010, it is the relative humidity, at step 020, that is being adjusted to reach a pre-determined level. In step 020, such adjustment can be made by adding water to the acid gas and/or decreasing the temperature of the acid gas to provide a humid gas (having a relative humidity between about 2% and about 90%). In the context of the present disclosure, it is important that the adjustment in the relative humidity of the gas be made prior to the addition of any amount of chalked lime. In an embodiment, the water that is being added at step 020 is fresh water and can be in a solid, liquid or gaseous form. Optionally, water that is being added at step 020 can result in a change in the temperature of the gas. For example, if the temperature of the water that is being added is different than the temperature of the acid gas, then the addition of water to the acid gas will either increase or decrease the acid gas temperature. In an embodiment, in step 020, gaseous water (e.g., water vapor) is added to an acid gas having an initial temperature lower than 100° C. and therefore increases the temperature of the acid gas. In another embodiment, in step 020, liquid or solid water is added to an acid gas having an initial temperature higher than the liquid or the solid water and therefore decreases the temperature of the gas. In a specific embodiment, the water that is being added at step 020 is in a liquid form (such as, for example, liquid droplets) and has a temperature of at least 20° C.

In combination or alternatively to the addition of water, step 020 can include modifying the temperature of the acid gas to obtain the pre-determined level of relative humidity. Since acid gases have a relatively high temperature, step 020 can include a step of lowering the temperature of the acid gas to obtain the pre-determined level of relative humidity. Preferably, the resulting humid gas has a temperature of at least 20° C.

Step 020 can optionally comprise characterizing the acid gas and/or the humid gas. Such characterization can include determining the type and concentration of pollutants in the acid/humid gas, the initial temperature of the acid/humid gas, the acid dew point temperature of the acid/humid gas, the flow of the acid/humid gas, the temperature of the acid/humid gas and/or the relative humidity of the acid/humid gas. Such characterization can be used to determine (at least in part), the amount of water to be added at step 020, the temperature decrease required at step 020 and/or the amount and/or the amount/type of chalked lime to be added at step 030.

In some embodiments, it is possible to monitor the relative humidity of the humid gas during step 020 (prior to conditioning with the sorbent) and/or after step 020 (for example after the filtering step discussed below). The pre-determined level of relative humidity can be determined or set based on information obtained during the process (e.g., contact time between the humid gas and sorbent, natural humidity/temperature of the acid gas before step 020, pressure). It is also contemplated that the relative humidity of the humid gas can be modulated (e.g., increased) to modulate the contact time with the sorbent to ultimately improve scrubbing efficiency.

The parameters for adjusting the relative humidity of the gas at step 020 can be determined in part on the initial characterization of the acid gas optionally conducted at step 010 as well as the optional characterization of the humid gas of step 020, the reaction mixture at step 030 or the filtered gas at step 050.

Step 020 thus comprises providing a humid gas having a relative humidity between about 2% and 90%. In an embodiment, the humid gas has a relative humidity of at least about 2%, 3%, 4%, 5%, 6%, 7%, 8%, 9%, 10%, 15%, 20%, 25%, 30%, 35%, 40%, 45%, 55%, 60%, 65%, 70%, 75%, 80%, 85% or 90% and/or of no more than 90%, 85%, 80%, 75%, 70%, 65%, 60%, 55%, 50%, 45%, 40%, 35%, 30%, 25%, 20%, 15%, 10%, 9%, 8%, 7%, 6%, 5%, 4%, 3% or 2%. In another embodiment, the humid gas has a relative humidity between about 20% and 90%, 35% and 70%, about 40% and 70%, about 45% and 70%, about 50% and 70%, about 55% and 70%, about 60% and 70% or about 65% and 70%. In still another embodiment, the humid gas has a relative humidity between about 35% and 65%, about 40% and 65%, about 45% and 65%, about 50% and 65%, about 55% and 65% or about 60% and 65%. In yet another embodiment, the humid gas has a relative humidity between about 35% and 60%, about 40% and 60%, about 45% and 60%, about 50% and 60% or about 55% and 60%. In still another embodiment, the humid gas has a relative humidity of about 60%.

The humid gas of step 020 has a temperature of at least 20° C. The reaction with the sorbent is preferably conducted at a temperature that is above acid dew point and/or above water dew point. In some embodiments, step 020 can also comprise providing a humid gas having a temperature at least equal to or higher than 10° C. than the acid dew point temperature of the acid gas. In an embodiment, the humid gas has a temperature at least equal to or higher than 10° C., 11° C., 12° C., 13° C., 14° C., 15° C., 16° C., 17° C., 18° C., 19° C., 20° C., 21° C., 22° C., 23° C. or 24° C. than the acid dew point temperature of the acid gas. In yet a further embodiment, the temperature difference between the humid gas and the acid dew point of the acid gas is between about 10° C. and 15° C., 11° C. and 15° C., 12° C. and 15° C., 13° C. and 15° C. or 14° C. and 15° C. In yet another embodiment, the humid gas has a temperature higher than about 15° C. when compared to the acid dew point temperature of the acid gas.

At the end of step 020, and before step 030, the water that has been added to the acid gas or the temperature restriction that has been imposed on the acid gas allows for the vaporization of the water in the humid gas. The relative absence of water in liquid state prior to step 030 allows for the reaction with the pollutant sorbent to be conducted in situ (in the gas).

Once the relative humidity and the temperature of the humid gas has been adjusted, the humid gas is supplemented with chalked lime at step 030 to provide a reaction mixture. As indicated herein, the chalked lime, in a dry form, is added to the humid gas to generate a reaction mixture. In the context of the present disclosure, the reaction mixture is not further being supplemented with water during the rest of the process. Such reaction mixture can comprise a gaseous fraction (comprising or not gaseous pollutants) and a solid fraction (comprising for example chalked lime as well as reaction products between the chalked lime and the pollutants). As indicated herein, since the process is a dry scrubbing operation, the chalked lime is provided in a dried form. Further, since the chalked lime is intended to be added to a humid gas, it is preferably injected as a powder form. Chalked lime can be provided in different particle size distributions depending on its intended use. In some embodiment, chalked lime can be provided in a particle size distribution, in which less than 10% of the particles have a size <0.045 mm and all of the particles (100%) have a size of <0.6 mm or even finer/smaller particle size distribution. The particle size distribution or amount of chalked lime to be added at step 030 can be in part determined on the initial characterization of the acid gas which has been optionally conducted at step 010, the characterization of the acid/humid gas which has been optionally conducted at step 020 and/or the characterization of the filtered gas at step 050. As shown herein, contacting a dry chalked lime with the humid gas (having the specifications mentioned in step 020) favors the catalysis of the chalked lime and increases the scrubbing efficiency of the process.

Step 030 can optionally comprise characterizing the reaction mixture that is being generated. Such characterization can include determining the reaction time between the sorbent and the pollutant(s), the flow of the mixture, the temperature of the mixture and/or the relative humidity of the mixture. The optional characterization of step 030 can be used to determine if the addition of water must be adjusted (e.g., increased or reduced) at step 020, if the temperature of the humid gas should be adjusted (e.g., increased or reduced) at step 020, if the reaction time between the humid gas and chalked lime should be adjusted (e.g., increased or decreased) and/or if the amount/type of chalked lime to be added to the humid gas at step 030 should be adjusted (e.g., increased or reduced).

Once the reaction mixture has been generated at step 030, it is submitted to a filtering step 050 to separate the solid particles fraction of the mixture from the gaseous fraction of the mixture. For example, the filter can separate particles from the gaseous fraction. Step 050 can optionally comprise characterizing the filtered gas (e.g., the gaseous fraction of the reaction mixture) or the solid fraction that is being generated. Such characterization can include determining the presence and/or concentration of potential pollutants in the filtered gas (and ultimately, the scrubbing efficiency of the process), the flow of the filtered gas, the temperature of the filtered gas and/or the relative humidity of the filtered gas. The optional characterization of step 050 can be used to determine if the addition of water must be adjusted (e.g., increased or reduced) at step 020, if the temperature of the humid gas at step 020 must be adjusted (e.g., increased or reduced) at step 020, if the amount of chalked lime to be added at step 030 to the humid gas should be adjusted (e.g., increased or reduced) and/or if another type of chalked lime should be used at step 030.

As indicated herein, the dry scrubbing process can efficiently occur in situ (inside the duct) and the use of a reactor to further increase the contact and/or the chemical reaction between the gaseous pollutants and chalked lime is obsolete. As also described herein, because the scrubbing efficiency is increased, the use of a sorbent recirculation means for reintroducing unreacted lime into the system is not necessary.

Dry Scrubbing System

The present disclosure also provides a system for implementing the process described herein, e.g., scrubbing pollutants from an acid gas. The system is a dry scrubbing system because the sorbent that is being used to scrub the acid gas, e.g., chalked lime, is provided in a dry form, i.e. no water has been added to the sorbent prior to its introduction in the system. In some embodiments, the system does not comprise a recycler for returning by-products of the reaction to be re-injected in the system. The system does not comprise a reactor for enhancing the chemical reaction between chalked lime and the gaseous pollutants.

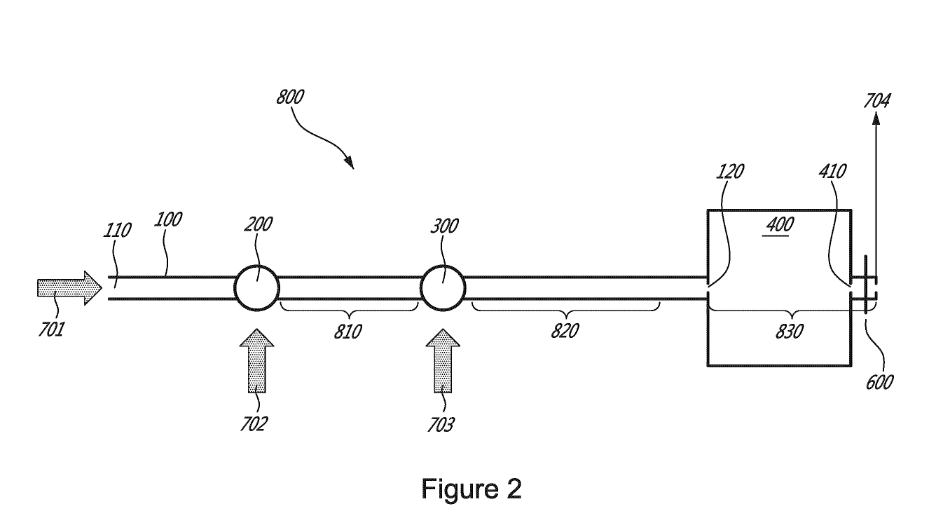

An embodiment of such a system is provided at FIG. 2. The system 800 defines at least three different zones: a humid zone 810 (in which the humid gas is formed because the water it contains is vaporized), a reaction zone 820 (in which the humid gas is admixed with chalked lime to provide a reaction mixture) and a filtering zone 830 (in which the reaction mixture is filtered to separate solid particles from the treated gas). The humid zone 810 and the reaction zone 820 can conveniently be located inside the duct 100. The system 800 comprises a duct 100 for carrying the gas that is intended to or has been treated with the chalked lime sorbent 703. Prior to its introduction in the system 800, the acid gas 701 comprises one or a plurality of pollutants, such as, for example, SO₂, SO₃, CO₂, HF, and NOₓ. As indicated above, such acid gas 701 can be generated during the processes known in the aluminum industry, such as, for example, coke production and alumina electrolysis.

In the embodiment shown on FIG. 2, the system is an in-line system and the person skilled the art will recognize that other configurations are possible. In FIG. 2, the duct 100 is a continuous tube, pipe or channel for carrying the acid gas 701 from one point of entry 110 to the filter 400. The duct 100 has a first opening 110 for allowing the acid gas 701 to enter the system 800 and a second opening 120 for allowing the gas in the reaction zone 820 to enter the filter 400. In the embodiment shown on FIG. 2, the gas flows from the first opening 110 to the second opening 120. In an embodiment, the duct can have multiple first openings 110 (not shown on FIG. 2), provided that such multiple first openings are located upstream (with respect to the flow of the gas in the system) of the means for modifying the relative humidity of the acid gas (e.g. water injector(s) 200). In zone 810, the duct is preferably composed of a material that is resistant to the acid corrosion that can be triggered by the condensation of the acid gas itself, the mixture of such acid gas with water and/or the products of the reaction between the acid gas and water.

The dry scrubbing systems described herein comprise means for modifying the relative humidity level of the acid gas 701 to provide a humid gas in zone 810. Such means can include, for example, water injectors and cooling systems. In the embodiment shown on FIG. 2, the system 800 comprises at least one water injector 200 for adding water 702 inside the duct 100 to the acid gas 701 flowing from the first opening 110 to the second opening 120. In some embodiments, the system can comprise multiple water injectors 200 (not shown on FIG. 2), provided that such multiple injectors 200 are located upstream (with respect to the flow of the gas in the system) of the sorbent injector(s) 300 and downstream (with respect to the flow of the gas in the system) of the one of more first openings 110. In the context of the present disclosure, the water injector(s) 200 cannot be located downstream (with respect to the flow of gas in the system) of any one of the sorbent injector(s) 300. The system described herein can further have a water reservoir (not shown on FIG. 2) for providing water to the at least one injector 200. The water 702 that is being added to the flow of gas inside the duct, can be in different states and/or have various pre-determined temperatures, depending on the characteristics of acid gas 701 (temperature, relative humidity, flow, acid pollutant concentration) provided by the process and the intended pre-determined relative humidity level. As an example, for a relatively hot acid gas 701, the water 702 added by injector 200 could be in a frozen state, but for a relatively cold acid gas 701, the water 702 added by injector 200 could be a water vapor. The water injector(s) 200 can be any suitable type of injector for providing water 702 in the required form to the scrubbing system (e.g., sprayer, vapor injector, snow injector, etc.). Since it may be required to increase or decrease the injection of water in the system, the injector(s) 200 can be configured to increase or decrease the flow of water passing there through. For example, at least two (and in some embodiments more injectors 200) can be organized in a water injection system (not shown in FIG. 2) which allows the opening or closure of at least one injector 200 based on the system's requirements. In another example, the water injector 200 can comprise a valve for controlling the flow of water passing there through. In the context of the present disclosure, the water 702 is fresh water (e.g., it is not a saline solution such as, for example, sea water).

In the dry scrubbing operations of the present disclosure, it is also contemplated that the temperature of the acid gas 701 be reduced to provide the required relative humidity levels. In such system (not shown on FIG. 2), a cooling system or a plurality of cooling systems can be used either in the presence or in the absence of the water injector(s) 200. The cooling system(s) is(are) provided upstream of any one of the solid sorbent injector(s) 300 (with respect to the flow of gas in the system) and downstream (with respect to the flow of the gas in the system) of any one of the first openings 110.

The increase in the relative humidity of acid gas 701 (either caused by the injection of water 702 via the water injector(s) 200 and/or the cooling systems) creates in the system 800 a humid zone 810 extending between the most upstream water injector 200 or of the cooling system and the most upstream sorbent injector 300 (both with respect to the flow of gas in the system). As indicated above, the sorbent injector provides the sorbent in a solid (particulate) form to the system 800. Humid zone 810 (located between the most downstream water injector and the most upstream sorbent injector with respect to the flow of the gas) is configured to favor the vaporization of the water present in the humid gas, i.e., the conversion of the liquid or solid water of the humid gas into a gaseous phase prior to contacting the solid pollutant sorbent. As such, the duct 100 of humid zone 810 must be long enough or wide enough to allow for the vaporization of the humid gas, prior to the injection of the solid pollutant sorbent.

The system 800 also comprises at least one sorbent injector 300 for adding chalked lime 703 inside the duct 100 to the humid gas of humid zone 810 flowing within the duct 100 towards the filter 400. In some embodiments, the system can comprise multiple sorbent injectors 300 (not shown on FIG. 2), provided that such multiple sorbent injectors 300 are located downstream (with respect to the flow of the gas in the system) of the water injector(s) 200 or of the cooling system and upstream (with respect to the flow of the gas in the system) to the filter 400. In the context of the present disclosure, the at least one or multiple sorbent injectors 300 cannot be located upstream (with respect to the flow of gas in the system) of any one of the water injector(s) 200 or of the cooling system. The system described herein can further have a chalked lime reservoir (not shown on FIG. 2) for providing chalked lime 703 to the at least one sorbent injector 703. In the context of the present disclosure, the chalked lime 703 that is being added to the flow of gas inside the duct is not admixed with a liquid (such as water) or a solution (such as an aqueous solution) prior to being added in the system 800. The chalked lime 703 prior to being added to the flow of gas must be in a dry form. The chalked lime injector 300 can be any suitable type of injector for providing chalked lime in a dry form to the scrubbing system. Since it may be required to increase or decrease the injection of chalked lime in the system, the sorbent injector(s) 300 can be configured to increase or decrease the flow of chalked lime 703 passing there through. For example, at least two (and in some embodiments at least three or more) sorbent injectors 300 can be organized in a chalked lime injection system (not shown in FIG. 2) which allows the opening or closure of at least one sorbent injector 300 based on the system's requirements. In another example, the sorbent injector 300 can comprise a valve for controlling the flow of chalked lime passing there through.

The injection of chalked lime 703 via the at least one sorbent injector 300 creates, in the system 800, a reaction zone 820 extending between the most upstream sorbent injector 300 (with respect to the flow of gas in the system) and the filter 400. In this reaction zone 820, the humid gas is being allowed to react in situ with the chalked lime. Such chemical reaction scrubs the humid gas from at least one pollutant (e.g., SO₂, SO₃, CO₂, HF and/or NOₓ) and converts the pollutants into reaction products which are either less toxic and, in some embodiments, reusable. Once the humid gas has entered the reaction zone 820 it is referred to as a treated gas.

The system 800 further comprises at least one filter 400 for receiving the treated gas from the reaction zone 820. The filter 400 is designed to separate solid particles (e.g., reaction products, unreacted chalked lime (if any)) from the treated gas to obtain a filtered gas 704. In the scrubbing system described herein, the gaseous concentration of at least one pollutant in the filtered gas 704 is lower than the corresponding gaseous concentration of the at least one pollutant in the untreated acid gas 701. In some embodiments, the system 800 comprises more than one filter 400 organized in series (not shown on FIG. 2). As indicated above, in the reaction zone 820, the chalked lime reacts with at least one pollutant and thus generates products comprising the pollutant, albeit in a less toxic form. Such products are usually in a solid form and the purposes of using a filter in the scrubbing system described herein is to remove such solid particles from the flow of treated gas. The solid particles can accumulate directly on the filter(s) of the filtering unit. Any type of filters which can remove the solid particles from the flow of gas can be used in the system of the present disclosure. Such filters include, but are not limited to bag filters, electrofilters and/or cartridge filters.

As described herein, the treatment of a humid gas with chalked lime enhances the efficiency of the system in scrubbing at least one or a plurality of pollutants. Without wishing to be bound by theory, it is postulated that the chalked lime-treatment of a humid gas increases the reactivity of the chalked lime with the pollutants. As such, it is not necessary to provide, in the system, a reactor which would further enhance the contact/reactivity between the chalked lime and the pollutants.

The system 800 can also comprise at least one probe 600 for measuring the temperature and/or the relative humidity of the gas entering the system, in the system or leaving the system. In the embodiment shown on FIG. 2, the probe 600 can be located downstream (with respect to the flow of the gas in the system) of the filter 400. However, the skilled person would recognize that more than one probe can be included in the system (not shown in FIG. 2). The at least one probe 600 can be used for determining if the process temperature (e.g., the temperature at which the reaction is being conducted) and/or the process relative humidity (e.g., the relative humidity at which the reaction is being conducted) is(are) adequate for maximizing the interaction between the chalked lime and the humid gas. Since the process temperature and relative humidity can be controlled by the addition of water via the at least one water injector 200 in the system, the measurements of the probe 600 can be relayed to a system controlling the influx of water in the system (not shown on FIG. 2). Alternatively or in combination, the measurement of the probe 600 can be relayed to a system controlling the cooling of the acid gas. For example, if the probe measures a temperature and/or relative humidity level which is out of target for the acid gas 701 in the gas/mixture present in the humid zone 810, the reaction zone 820 and/or the filtering zone 830, this information can be relayed to a controlling system to increase the flow of water 702 via the at least one injector 200 and/or to modulate the temperature of the humid to target in section 810. In another example, if the probe measures a temperature which is less than 10° C. above the acid dew point of the acid gas 701 in the gas/mixture present in the humid zone 810, the reaction zone 820 and/or the filtering zone 830, this information can be relayed to a controlling system (for example the water injector system described above) to decrease the flow of water 702 via the at least one injector 200 or the cooling of the acid gas to augment the temperature of the humid gas significantly above the acid dew point of the acid gas 701. In still another example, if the probe measures a relative humidity below 2% in the gas/mixture present in the humid zone 810, the reaction zone 820 and/or the filtering zone 830, this information can be relayed to a controlling system (for example the water injector system described above) to increase the flow of water 702 via the at least one water injector 200 or the cooling of the acid gas to augment relative humidity to no more than 90%. In yet another example, if the probe measures a relative humidity above 90% in the gas/mixture present in the humid zone 810, the reaction zone 820 and/or the filtering zone 830, this information can be relayed to a controlling system (for example the water injector system described above) to decrease the flow of water 702 via the at least one water injector 200 or the cooling system to decrease relative humidity to no less than 2%. The at least one probe 600 can be located in the humid zone 810, the reaction zone 820 and/or the filtering zone 830 (not shown on FIG. 2). In an embodiment, the at least one probe 600 can be located upstream or downstream the injector 200, downstream or upstream of the cooling system, upstream or downstream of the sorbent injector 300 and/or upstream or downstream of the filter 400 (all with respect to the flow of gas in the system) In the embodiment shown on FIG. 2, the probe 600 can be located downstream of the filter 400. In yet another embodiment not shown on FIG. 2, the scrubbing system comprises at least two probes 600, a first probe located in the humid zone 810 (e.g., downstream the water injector 200 or the cooling system and upstream of the sorbent injector 300, both with respect to the flow of gas in the system) and a second probe located downstream of the filter 400.

The dry scrubbing system described herein can be a portable mobile unit or a fixed unit. Such mobile dry scrubbing systems comprise or consist of the duct, at least one water injector or a cooling system, at least one chalked lime injector and the filter described herein. The mobile or immobile dry scrubbing system can further comprise at least one probe as described herein. Further, the mobile dry scrubbing system lacks any reactor.

The present invention will be more readily understood by referring to the following examples which are given to illustrate the invention rather than to limit its scope.

### EXAMPLE

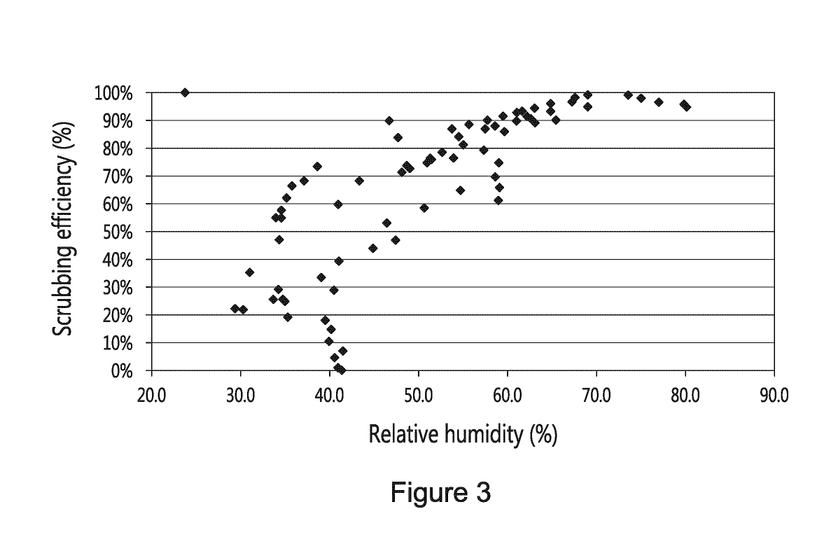

First trial. It was first determined if an increase in the relative humidity and a corresponding decrease in temperature of the gas to be treated could be beneficial to enhance scrubbing efficiency. In order to do so, a scrubbing system comprising a water injector and filters were used (no reactor nor recycling system were used). An SO₂-laden gas was introduced into the system and various parameters were measured. Various amounts of water were added to the SO₂-laden gas at pre-determined intervals to obtain a process temperature between 35 and 80° C. FIG. 3 shows the results of all the runs of the first trial and the different levels of scrubbing efficiency achieved, at different level of relative humidity.

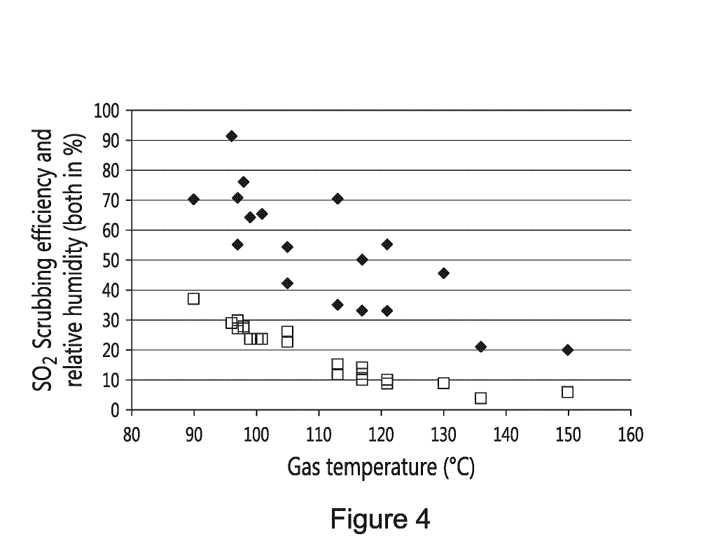

Second trial. The pilot system was scaled up and the effects of gas temperature and relative humidity on scrubbing efficiency were determined. As shown on FIG. 4, scrubbing efficiency increased in function of the relative humidity of the gas. However, scrubbing efficiency decreased in function of the temperature. As further shown on FIG. 4, scrubbing was possible at low temperatures, even at temperatures below 100° C.

Third trial. The pilot system of the second trial was used over a period of 4 days. When the gas is humidified (e.g., to have a water content between 35 to 77 g/m³) and cooled (e.g., by 30-35° C.), it is possible to lower the concentration of SO₂ in the treated gas (when compared to the initial gas) by 100 ppm.

While the invention has been described in connection with specific embodiments thereof, it will be understood that the scope of the claims should not be limited by the preferred embodiments set forth in the examples, but should be given the broadest interpretation consistent with the description as a whole.

What is claimed is:

1. A dry scrubbing system for reducing the concentration of a pollutant from an acid gas, said dry scrubbing system comprising:
a first duct for carrying the acid gas, wherein the first duct defines a first opening allowing entry of the acid gas in the dry scrubbing system and a second opening for carrying a treated gas;
at least one sorbent injector operatively connected to the first duct for adding chalked lime inside the first duct;
means for adjusting the relative humidity of the acid gas operatively connected to the first duct, wherein the means for adjusting the relative humidity of the acid gas is at a location between the first opening and the at least one sorbent injector; and
at least one filter for separating solid particles from the treated gas, wherein the filter is connected to the second opening of the first duct and wherein the filter is connected to a third opening of a third duct allowing exit of the treated gas from the dry scrubbing system.

2. The dry scrubbing system of claim 1, wherein the means for adjusting the relative humidity of the acid gas is at least one water injector for adding water inside the first duct.

3. The dry scrubbing system of claim 2, wherein the at least one water injector is for injecting liquid water.

4. The dry scrubbing system of claim 2 or 3, wherein the location of the at least one water injector with respect to the location of the sorbent injector allows the vaporization of the water of the acid gas prior to contacting the chalked lime.

5. The dry scrubbing system of any one of claims 1 to 4, further comprising at least one probe for determining the temperature and/or the relative humidity of the acid gas and/or the treated gas.

6. The dry scrubbing system of claim 5, wherein the at least one probe is proximal to the third opening and/or the means for adjusting the relative humidity of the acid gas.

7. A process for reducing the concentration of at least one pollutant from an acid gas, said process comprising:
(a) providing an initial acid gas comprising the pollutant;
(b) modifying the initial acid gas to obtain a humid gas having a relative humidity between about 2% to 90%;
(c) adding chalked lime to the humid gas to obtain a reaction mixture; and
(d) filtering the reaction mixture to separate solid particles and obtain a filtered gas having a reduced concentration of the at least one pollutant when compared to the initial acid gas.

8. The process of claim 7, wherein step (b) further comprises adding water to the initial gas and/or reducing the temperature of the initial gas to obtain the humid gas.

9. The process of claim 7 or 8, wherein the pollutant is at least one of SO₂, SO₃, CO₂, HF, NOₓ and combinations thereof.

10. The process of any one of claims 7 to 9, wherein the acid gas is an emission from a calcined coke production facility or an alumina electrolysis facility.

11. The process of any one of claims 7 to 10, wherein the relative humidity of the humid gas is about 60%.

12. The process of any one of claims 7 to 11, wherein the particles of the chalked lime have a relative size of less 0.045 mm for at least 10% of the particles and less than 0.6 mm for 100% of the particles.

13. The process of any one of claims 7 to 12, further comprising
(e) determining the relative humidity of the filtered gas; and
(f) further modifying the initial gas at step (b) if the relative humidity of the filtered gas is less than about 2% or more than about 90%.
